(19) United States
(12) Patent Application Publication
(10) Pub. No.: US 2007/0008986 A1
(43) Pub. Date: Jan. 11, 2007

(54) Method and system for configuring a queue profile

(75) Inventors: Dong Xie, Holmdel, NJ (US); Larry H. Chang, Holmdel, NJ (US); Bernyhard Suter, Brich, NJ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Incorporated, Alameda, CA (US)

(21) Appl. No.: 11/176,873

(22) Filed: Jul. 7, 2005

(51) Int. Cl. H04L 12/56; H04L 12/66

(52) U.S. Cl. 370/412; 370/463

(57) ABSTRACT

A method and system is disclosed for configuring a queue profile based on an input values received from a user. According to an exemplary embodiment, a series of threshold queue sizes are generated based in part on the input values and a corresponding series of drop priority values. A lookup table may be provided to categories the threshold queue sizes within predetermined queue size blocks.

### BACKGROUND

I. Field of the Invention

The present invention is directed toward queue management, and more specifically, toward configuring queue drop thresholds.

II. Related Art

Switches and routers for modern data networks require ever-increasing capacities for high speed and efficient packet buffering. A typical switch or router generally consists of multiple packet processing cards (PPC) each of which may serve multiple ingress and egress ports. At any given moment, a PPC may have packet data arriving on several of these ingress ports. This packet data may require a certain amount of time to be processed, and in the interim the packet data must be buffered until is ready to be sent to an output port, possibly to another PPC. Buffered data packets are generally stored in a queue. The buffer management function is commonly referred as scheduler, while a buffer entity is referred as a queue.

The PPC may have a large number of queues. At the queue, a packet experiences a queuing delay as it waits to be transmitted. This queuing delay depends upon the number of bytes ahead in the queue as well as the emission bandwidth of the queue itself.

Each arriving packet is first subjected to admission control before accepted into the. The admission control policy can exert real time queue depth control based on configuration criteria, packet classification, and network bandwidth utilization. The packet classification may provide each packet with a drop priority indicator (DPI) that indicates its priority level for admission control. Generally, DPI may be a three bit value. Commonly, a DPI of zero assigned to the lowest priority packets while a DPI of seven is assigned to the highest priority packets that require stricter delay.

The queue may be configured with a plurality of drop threshold values, each drop threshold value associated with a DPI value. The drop threshold value may be measured in bytes and used to determine whether an incoming packet having a given DPI value will be dropped instead of been accepted into the queue.

### SUMMARY

A packet processing card (PPC) may have a large number of queues and potential queue drop threshold values. For instance, in an embodiment, a PPC is configured to allow up to 256K physical queues. Furthermore, a group of physical queues can be combined into a logical queue, for which the queue configuration is applied. The queue configurations may include the maximum allowed queuing delay and bandwidth, which may be user specified or implicitly derived from interface attributes. In addition, each physical queue may have multiple queue drop threshold values. Because of the large number of potential drop threshold values, the process of determining and setting an appropriate value for each queue drop threshold can be tedious and quite time consuming. Further, inputting drop threshold values in terms of bytes may be difficult—especially because a queuing delay is a factor of both the number of bytes in the queue (as limited by the drop threshold) and the output rate (bandwidth) of the queue. Additionally, allowing a user to select any value for the queue drop thresholds may result in higher system complexity than if the queue drop thresholds were limited to a predetermined set of values. In an embodiment, the logrithmetically scaled discrete drop threshold table reduces system complexity without sacrificing functionality.

With these and other issues in mind, presently disclosed is a system and method for queue management. According to an exemplary embodiment, a PPC is provided having at least one queue. Through a command line interface, such as a telnet session, a user may initiate the selection of a series of queue drop threshold values based on several predetermined factors as well as a queuing delay value entered by the user.

According to the embodiment, the PPC receives two input values (from the user) that are indicative of a maximum allowable delay (t) at the queue and the maximum output bandwidth (BW) of the queued packets. Using the input values and a set of predetermined data, the PPC generates a series of threshold queue sizes. Each threshold queue size corresponds with a drop priority indicator in a one-to-one relationship. As such, packets arriving at the queue that are associated with a given drop priority indicator will also be associated with the corresponding threshold queue size. The input value (BW) can be explicitly specified for the queue or programmatically derived from the interface attributes such as input or output queue, port bandwidth and hardware properties.

In a further embodiment, generation of the series of threshold queue sizes is done by calculating an associated threshold queue size (TQS) for each drop priority indicator (DPI) based on the delay (t), bandwidth (BW), and a constant (K) for unit conversions using the equation:

$$TQS = \frac{K * BW * t}{{2}^{DPI}} .$$

TQS may be measured in bytes.

In the preferred embodiment, possible values for a threshold queue size have a lower bound, an upper bound, and a set of discrete values. Operationally, potential values are stored in a lookup table at the PPC. According to the embodiment, a calculated value for threshold queue size is modified to match with the next smaller threshold queue size value listed in the lookup table. In an embodiment, the table includes threshold queue size values ranging from 2040 bytes to 503,316,480 bytes and following a logarithmic scale. Further, the table may be stored in a field programmable gate array (FPGA) and keyed to a threshold index (7 bit) and a DPI (3 bit). The design does not inherently limit the size of the table and the two indices. The threshold index is computed from the queue configuration parameters and the DPI is typically generated by the packet classifier.

In the operational system, a PPC includes at least two ports and associated queues. The PPC may be operationally configured through a command line interface telnet session or via other means. A table of discrete drop threshold values, as described above, is computed and loaded into memory during PPC power-on initialization. When a logical queue is configured and attached to an interface, the software computes a drop threshold index to the table for each of its physical queue.

### BRIEF DESCRIPTION OF THE DRAWINGS

FIG. 1 is a schematic of a packet processing card;

FIG. 2 is a flow chart showing calculation of a series of drop threshold values

### DETAILED DESCRIPTION

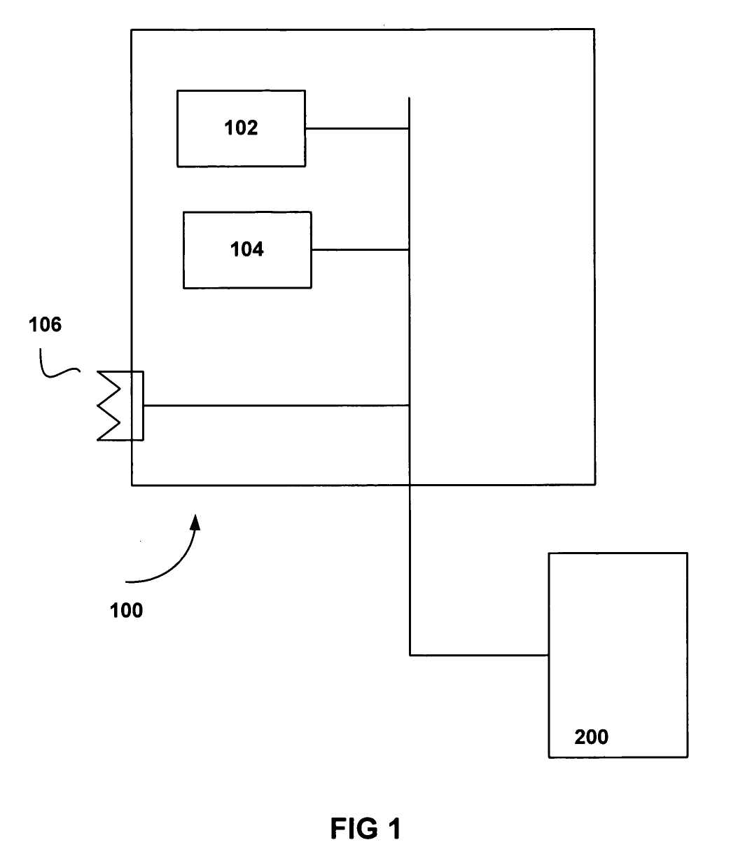

FIG. 1 provides a schematic of a packet processing card (PPC) 100 in accordance with an exemplary embodiment. The PPC 100 includes a field programmable gate array (FPGA) 102 that includes predetermined program logic for carrying out functions of the PPC including functions associated with establishing a queue profile. The FPGA may implement digital logic much faster than a software based computer program. In the embodiment, two FPGA based schedules are used for each queue: (i) a traffic ingress scheduler (TIS) and (ii) a traffic output scheduler (TOS). The scheduling functions may be implemented using hardware description language and loaded into the FPGA. Data storage 104 may include a combination of FPGA internal high speed memory for drop threshold table and external packet buffer memory pool supported by an ASIC, for instance. The data storage 104 may be configured to store buffered packets in any number of queues. For instance, in a preferred embodiment, the PPC 100 may be configured to hold up to 256K physical. A logical queue may be grouped by up to eight physical queues, referred as sub-queues (although another implementation provides for up to four sub-queues). A physical queue is a physical resource that the PPC uses for admission control, packet storage and scheduling. On the other hand, a logical queue may comprise a group of sub-queues with common user defined traffic classification rules and maximum allowed bandwidth for output scheduling.

The PPC 100 is generally configured to process a high packet rate. As such, multiple memory channels may be needed in order to sustain this packet rate.

Packets flow in and out of the PPC 100 via ports 106. The ports 106 may be include a layering of port types including physical ports, virtual ports, and interfaces. In an implementation, the hierarchy is as follows: Physical Port←Virtual Port←Interface. Thus, each physical port can have a number of virtual ports, and each virtual port can have a number of interfaces. As an example, a physical port may be a 100 mbps Ethernet port that has one virtual port and up to 4094 virtual LAN interfaces. Further, each interface may support multiple logical queues for different classes of traffic. A logical port can be 155 mbps channel of a SONET port. The ports 106 generally facilitate bi-directional transmission within a fixed bandwidth.

A user may access and change a queue profile that may be stored on the PPC 100. According to the embodiment in FIG. 1, an access device 200, such as a computer terminal provides access to the PPC 100 and a stored queue profile. The access device 200 may include a command line interface, such as a telnet session, that allows the user to communicate with the PPC 100. Of course, embodiments may support multiple modes of establishing a connection, such as unsecured telnet, ssh for secured shell and/or XML.

According to a preferred embodiment, each sub-queue at the PPC 100 may be assigned a plurality of queue drop thresholds—each drop threshold being associated with a drop priority indicator. In the embodiment, the command line interface provides an opportunity for the user to indicate a parameter (input value) that is used to determine a queue drop threshold for each drop priority indicator (DPI) level allowed by the queue.

In order to determine the queue drop thresholds, the input values may provide an indication of a maximum allowed queue delay for a packet having given DPI (such as DPI=0) and the maximum allowed output bandwidth. For instance, the input value may be the maximum number of microseconds that a packet with a lowest priority (DPI=0) may be delayed in the queue when packets are being scheduled at a given bandwidth. Using the input values, the PPC may calculate a series of drop threshold queue sizes—one for each DPI level.

In the embodiment, the queue threshold size may range from a lower bound to an upper bound and fit within a set of discrete sizes. For instance, the lower bound may be 2,048 bytes, thus allowing at least one packet of 1,500 bytes, a default maximum packet size, to fit in the queue. The upper bound may be 503,316,480 bytes or other as limited by hardware memory on the PPC 100. Each queue threshold may be selected from a set of discrete threshold sizes that are provided in a pre-computed lookup table stored on a FPGA aboard the PPC 100. In the embodiment, the pre-computed lookup table includes 128 possible discrete drop threshold values for each DPI value in the queue. In a queue using eight drop priority indicators (DPI)—and thus eight drop threshold values—there would thus be 1024 possible discrete drop threshold values. In one embodiment, this lookup table size is corresponds to the FPGA hardware allowance for a 10 bit (1024) lookup table. In this case, a 7 bit table index may be coupled with 3 bit index for the DPI value to form a pointer to the table.

In the embodiments using a discrete set of drop threshold values, the values may be listed in a series following a logarithmic scale, a linear scale, or another function. Table 1 provides a portion of a drop threshold value lookup table keyed to a given DPI and using a logarithmic scale to determine the drop threshold values. The first column of Table 1 includes an index that serves as a lookup value. In the example, the index values range from 0 to 127. The second column includes drop threshold values associated with the index value. These drop threshold values correspond to possible discrete drop threshold values for the given DPI. A drop threshold value of zero bytes at index number 0000 provides a special case. The 0000 entry may be used when the queue is deleted and/or to indicate that the queue is to be flushed.

TABLE 1

| Threshold | TQS₀, Drop Threshold Value |
|---|---|
| Index | for DPI = 0 (bytes) |
| 0000 | 0 |
| 0001 | 2048 |
| 0002 | 2304 |
| 0003 | 2560 |
| 0004 | 3072 |
| 0005 | 3328 |
| 0006 | 3584 |
| . . . | . . . |
| 0124 | 436207616 |
| 0125 | 469762048 |
| 0126 | 503316480 |
| 0127 | 503316480 |

Most often, the DPI are ordered from 0 to n, where n is an integer such as 7. Packets having a drop priority indicator of 0 are considered lowest priority packets for packets that can tolerate longest delay while those with priority indicator of n are considered highest priority packets for packets that require shorter delay.

The drop threshold values in Table 1 provide a threshold or maximum queue size associated with a specific DPI (0) for the queue. The queue values are shown in Table 1 as measured in bytes. This is useful because hardware limits are also often measured in bytes. However, other measurements are available including both (i) storage units such as kilobytes and megabytes and (ii) temporal units such as microseconds (ms).

In a further embodiment, the lookup table includes a plurality of entries, each entry having a drop threshold index value (index value); a drop priority indicator value (DPI value); and a threshold queue size. As mentioned, the index value and DPI value may be combined to form a single lookup value.

Queue Delay

The amount of time (delay) that a given packet will rest in a queue depends upon a number of factors including the number of packets to be processed before the given packet (depth of the queue), the sizes of these packets, as well as the speed at which the packets are being scheduled (bandwidth).

Thus, queue delay will depend upon the total number of bytes of the packets that were already admitted into the queue. Packets can be limited to a maximum queue delay by discarding packets that would exceed its threshold queue size.

Packets

Each packet in a queue carries a service priority indicator (SPI) and a drop priority indicator (DPI). In this embodiment, each indicator is 3 bits—resulting in eight possible values. However, the TQS algorithm does not preclude other SPI and DPI sizes. The SPI and DPI can either be supplied into the system explicitly or set within the system by quality of service (QoS) classification rules that may include traffic policer and classification rules. Further, the QoS classification rules may be defined by a user. The SPI is used to select a sub-queue within a logical queue while the DPI is used for admission control of that sub-queue.

Calculating Queue Drop Thresholds

The PPC may calculate a series of threshold queue sizes (TQS) based at least on (i) an input value (t) indicative of a maximum queue delay for a given DPI and (ii) an input value indicative of a maximum allowed packet scheduling bandwidth. For instance, a TQS for DPI=0 may be calculated as TQS₀=K*BW*t. Of course, other values could be used for the given DPI. The bandwidth may be explicitly specified by the user or computed dynamically.

As mentioned, in the preferred embodiment, only a discrete set of values are available for each TQS. Accordingly, the calculated TQS may be converted to a discrete TQS value by locating a drop threshold value entry from the lookup table that includes a range including the calculated TQS.

In a preferred embodiment, the drop threshold value entry is selected that is the minimum value in the table that is at least as large as the calculated TQS. (Round up to the next higher entry). According to the embodiment, any packets that would have been queued after this threshold setting may exceed the maximum delay limit. In another embodiment, the drop threshold value located in the table is the maximum drop threshold value entry that is less than the calculated TQS. In addition, the discrete TQS value may be limited by an upper bound and lower bound.

A TQS can be calculated for each other DPI using the equation

$${TQS}_{DPI} = \frac{K * BW * t}{{2}^{DPI}} or {TQS}_{DPI} = \frac{{TQS}_{0}}{{2}^{DPI}} .$$

These values for the TQS may then be converted to discrete form by locating the associated drop threshold value entry in the lookup table. In a further embodiment, the calculation may include a value for the lower queue size bound

$$( m ) \text{:} {TQS}_{DPI} = max ( \frac{K * BW * t}{{2}^{DPI}} , m ) .$$

Note: the max(x,y) function returns the maximum of two numbers. Of course, in this embodiment, it is possible that there will not be a one-to-one relationship between DPI and threshold queue size.

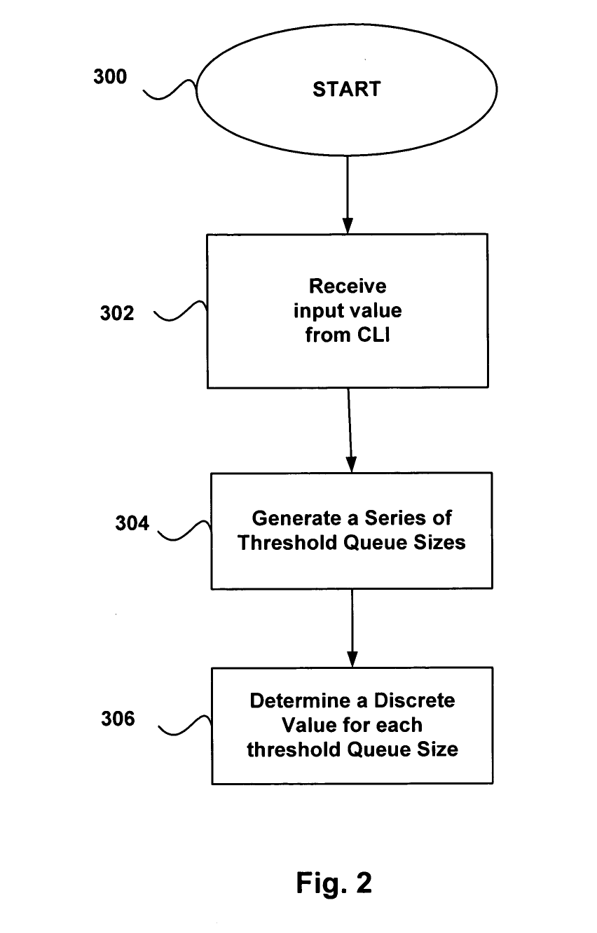

FIG. 2 is a flow chart showing an example method of determining a series of queue threshold sizes for each DPI. The flow chart begins at 300. At 302, the PPC receives an input value from a user. According to the embodiment, the input value is entered at a command line interface (CLI) such as at a telnet session. According to the preferred embodiment, the input value is a maximum period of time of an acceptable queuing delay for a packet to be admitted to a sub-queue.

At 304, a series of threshold queue sizes is calculated at the PPC. The calculation logic may, for instance, be stored in FPGA at the PPC or located elsewhere. Preferably, the series of threshold queue sizes relates to a series of DPI's—Each DPI being associated with a threshold queue size. In an embodiment, higher priority DPI's are associated with smaller threshold queue sizes.

At 306, the calculated threshold queue sizes are converted to discrete values obtained from a lookup table stored in FPGA at the PPC. The limited number of potential values for each threshold queue size allows for more rapid processing, reduces system complexity and cost.

Preferred embodiments have been described herein. It is to be understood, however, that changes and modifications can be made without departing from the true scope and spirit of the system. Other embodiments of the present invention, of course, will be apparent to those of ordinary skill in the art upon their review of the detailed description. No one embodiment should be deemed to be controlling, as all embodiments of the present invention are deemed to be covered by the appended claims. Certainly, the invention must be interpreted to encompass technological improvements not yet developed and/or available to the public. The following claims and their equivalents, which are to be interpreted in light of the foregoing specification, define the true scope and spirit of the invention.

We claim:

1. A method for configuring a queue profile comprising:
receiving input values indicative of a maximum allowable delay at the queue and a bandwidth;
generating a series of threshold queue sizes based at least in part on (i) the input values and (ii) a series of drop priority indicators; and
for each threshold queue size, querying a threshold lookup table to determine a discrete drop threshold value associated with a range of queue sizes that includes the threshold queue size.

2. The method of claim 1, wherein receiving input values comprises receiving input values through a command line interface.

3. The method of claim 2, wherein the command line interface operates via a telnet session.

4. The method of claim 1, wherein the threshold lookup table includes a plurality of discrete drop threshold values, wherein each discrete drop threshold value is a member of a limited group of discrete drop threshold values available at the queue.

5. The method of claim 1, wherein generating the series of threshold queue sizes comprises:
for each drop priority indicator (DPI) calculating an associated threshold queue size (TQS) based on a first input value (t), a second input value (BW), exponent value (n) and a predetermined constant (K) using the equations: TQS₀=K*BW*t and
$${TQS}_{DPI} = \frac{{TQS}_{0}}{{n}^{DPI}} .$$

6. The method of claim 5, wherein the exponent value (n) is 2.00.

7. The method of claim 5, wherein the input value (BW) is either (i) explicitly specified for the queue or (ii) programmatically derived from interface attributes.

8. The method of claim 1, wherein generating the series of threshold queue sizes includes:
determining a maximum threshold queue size, wherein the maximum threshold queue size is based at least in part on the allowable delay and bandwidth configured for the queue; and
associating the maximum threshold queue size with a first drop priority indicator of the series of drop priority indicators.

9. The method of claim 8, wherein generating the series of threshold queue sizes further includes:
determining a second threshold queue size, wherein the second threshold queue size is based at least in part on the first threshold queue size; and
associating the second threshold queue size with a second drop priority indicator of the series of drop priority indicators.

10. The method of claim 8 wherein generating the series of threshold queue sizes further comprises:
determining values for each of the series of threshold queue sizes,
wherein the values are each not greater than the maximum threshold queue size, and
wherein comparatively, threshold queue size values associated with greater drop priority indicators are not greater than threshold queue size values associated with lesser drop priority indicators.

11. The method of claim 1, wherein the threshold lookup table includes a plurality of entries, each entry comprising:
a drop threshold index value;
a drop priority value; and
a threshold queue size.

12. The method of claim 1, wherein querying the threshold lookup table to determine a drop threshold index value for a range of queue sizes including the threshold queue size includes:
in the threshold lookup table, locating the maximum drop priority lookup value that is less than the threshold queue size;
determining the drop threshold index value associated with the located maximum drop priority lookup value.

13. At a queue having a series of configurable threshold queue sizes where each threshold queue size has a corresponding drop priority indicator, a method of configuring the threshold queue sizes comprising:
receiving an input value from a user, wherein the input value is indicative of a maximum allowable delay at the queue for packets having a lowest drop priority indicator; and
based in part on the input value, the corresponding drop priority indicator, and a bandwidth, determining a threshold queue size for each of the series of configurable threshold queue sizes.

14. The method of claim 13, further comprising:
associating each threshold queue size with an entry in a threshold lookup table stored in memory.

15. The method of claim 14, wherein the threshold lookup table includes a plurality of threshold queue size values keyed at least to a threshold index.

16. The method of claim 13, further comprising:
receiving a second input value from the user, wherein the second input value is indicative of the bandwidth in bits per second, and
wherein the input value is indicative of a number of microseconds.

17. The method of claim 13, wherein determining the threshold queue size for each of the series of configurable threshold queue sizes includes:
for each threshold queue size (TQS) having an associated drop priority indicator (DPI), calculating the TQS based on the delay (t), bandwidth (BW) and a constant (K) using the equation:
$$TQS = \frac{K * BW * t}{{2}^{DPI}} .$$

18. The method of claim 13, wherein determining the threshold queue size for each of the series of configurable threshold queue sizes includes:
for each threshold queue size (TQS) having an associated drop priority indicator (DPI), calculating the TQS based on the delay (t), bandwidth (BW), a constant (K), and a minimum queue size (m) using the equation:
$$TQS = max ( \frac{K * BW * t}{{2}^{DPI}} , m ) .$$

19. The method of claim 13 wherein determining the threshold queue size for each of the series of configurable threshold queue sizes includes:
determining a maximum threshold queue size based on the input value and a predetermined constant;
determining values for each of the series of configurable threshold queue sizes, wherein the values are each not greater than the maximum threshold queue size, and
wherein comparatively, threshold queue size values associated with greater drop priority indicators are not greater than threshold queue size values associated with lesser drop priority indicators.

20. A system for setting a queue profile comprising:
a queue configured to include a plurality of configurable threshold queue sizes where each threshold queue size has a corresponding drop priority indicator;
a user interface for receiving input values from a user, wherein the input values are indicative of maximum allowable queuing delay and scheduling bandwidth at the queue;
a threshold lookup table keyed to at least a drop threshold index, wherein the threshold lookup table includes a reference threshold queue size for each entry in the drop threshold index, the threshold index corresponding to TQS₀ being stored in hardware.

21. A system for packet admission control comprising:
hardware logic for (i) associating a series of threshold queue sizes with entries in a threshold lookup table; (ii) packet processing to assign an input logical queue and an output logical queue for each incoming packet, (iii) identifying the current queue depth, (iv) obtaining a SPI and a DPI value from a packet classifier, wherein the SPI value determines a sub-queue within the logical queue, (v) retrieving a threshold index for the sub-queue determined by the SPI value, and (vi) combining the threshold index with the DPI to lookup a TQS_{DPI}, wherein the lookup returns a maximum allowed queue depth for packet admission control.
